(19) United States
(12) Patent Application Publication
(10) Pub. No.: US 2019/0389697 A1
(43) Pub. Date: Dec. 26, 2019

(54) LOW-COST HOME LIFT

(71) Applicant: MARVIN M. MAY, LOS ANGELES, CA (US)

(72) Inventor: MARVIN M. MAY, LOS ANGELES, CA (US)

(21) Appl. No.: 16/504,330

(22) Filed: Jul. 8, 2019

Related U.S. Application Data
(63) Continuation-in-part of application No. 16/015,186, filed on Jun. 22, 2018, now abandoned.

(51) Int. Cl. B66B 9/00; B66B 11/04; B66B 13/16; B66B 1/36; B66B 5/12

(52) U.S. Cl. CPC B66B 9/00; B66B 11/043; B66B 5/12; B66B 13/16; B66B 1/36; B66B 11/0415

(57) ABSTRACT

An improved home lift having a simplified design and utilizing components that is simple and economical to install and designed for economical, temporary rental or lease installations as well as permanent installations. Complete installations cost far less than any existing home lift of the prior art and most stair climbers. The components include an optional steel tower frame or a support post and beam assembly, a carriage designed to carry a passenger with or without a wheelchair, a counterweight, and a set of pulleys configured to guide two cables. Both cables are attached to the carriage and the counterweight. The load weight and the counterweight are equal and balanced, requiring so little-force that the home lift may easily be operated manually by the passenger or an aide.

### CROSS-REFERENCE TO RELATED APPLICATIONS

The present application is a continuation in part application to U.S. utility application Ser. No. 16/015,186 filed Jun. 22, 2018 entitled “Improved Home Elevator”, the disclosure hereby incorporated in its entirety at least by reference.

### BACKGROUND OF THE INVENTION

### 1. Field of the Invention

The present invention generally relates to accessibility devices, but more particularly to a low-cost home lift.

### 2. Description of Related Art

It is well known that there are many challenges when disabled or elderly, including traveling up and down stairs, which can be extremely dangerous. Currently, there are two major solutions, home elevator systems and stair climbers. Elevator systems are cumbersome and very expensive. Stair climbers are mechanical systems installed adjacent to a set of stairs, to assist a disabled or elderly person up and down the set of stairs. Usually, the person sits on a chair fastened to the stair climber. Stair climbers offer an economic solution to elevators, especially for straight stairs without curves or turns. However, when staircases are curved stair climbers become more complicated and expensive. If a handicapped person is unable, or might become unable, to use a stair climber, the only present alternatives, are the possibility of the home and its elevator location being able to meet the specific requirements of a more expensive elevator, or moving to a different home. Consequently, there is a need for an economic solution that can be used in homes regardless of which type and shape of staircase exists. There is an unmet need for lifting wheelchair patients with short term injuries and for handicapped seniors needing a lift for an unknown period. Their alternatives are unnecessarily very expensive and life-changing at a difficult period of their lives.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a home lift is provided, comprising a carriage sized and shaped to carry a passenger with an optional mobility vehicle, the carriage, the passenger, and the optional mobility vehicle defined as a load having a first weight; a counterweight having a second weight, wherein the first weight is equal to the second weight; a set of pulleys configured to guide at least two ropes, wherein the at least two ropes are attached to the carriage and the counterweight; and, wherein the passenger using a manual force may move the carriage between at least two adjacent floors in the home.

In one embodiment, a self-supporting temporary tower frame configured to support the home lift is provided. In one embodiment, the set of pulleys is attached to the tower frame. In another embodiment, the tower frame includes cross braces. In another embodiment, the home lift is supported by an existing support wall or roof beam. In yet another embodiment, a support post and a horizontal beam configured to support the home lift is provided, wherein the horizontal beam is configured to support the set of pulleys and the support post is situation outside the home. In another embodiment, the horizontal beam is configured to enter a window of the home. In another embodiment, a third rope attached to the carriage and a fourth rope attached to the counterweight are provided, wherein the passenger using the third rope and the fourth rope is enabled to move the carriage between the at least two adjacent floors in the home. In another embodiment, a battery operated winch or hand drill connected to the third and/or fourth rope is operable to move the carriage between the at least two adjacent floors in the home such that the manual force is not required. In another embodiment, an additional stationary rope attached to a fixed location is provided, wherein the additional rope enabled the passenger the required leverage force to move the carriage between the at least two adjacent floors in the home. In another embodiment, a second additional movable rope configured to travel with the load and the counterweight, wherein the second additional movable rope is operable for a user outside the carriage, such as an aide. In another embodiment, the at least two ropes include a main rope and a backup rope, wherein the main rope is a steel rope and the backup rope is a Kevlar rope. In another embodiment, the set of pulleys includes two grooves for the main rope and the backup rope. In yet another embodiment, the carriage includes a locking mechanism configured to lock the carriage in place when the load is not is not in the carriage preventing the carriage from traveling. In another embodiment, the carriage includes a gate and the gate operation is in conjunction with the locking mechanism, such that when the passenger exits the carriage the gate opens and locks the carriage in place. In another embodiment, one or more cleats are provided enabling the passenger to tie down the carriage to prevent unwanted movement. In another embodiment, a brake system is provided, wherein the brake system is configured to engage the at least two ropes preventing the carriage from moving when the brake system is engaged. In another embodiment, the carriage is stationary until a small force is applied to raise or lower the carriage.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIGS. 1A-B are sectional views of a low-cost home lift according to an embodiment of the present invention.

FIGS. 2A-B are detailed views of structural towers according to an embodiment of the present invention.

### DETAILED DESCRIPTION OF THE PREFERRED EMBODIMENT

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

There are several advantages of the present invention compared to existing home elevators and stair climbers, including but not limited to installation, simplicity of components, safety features, and cost. There are several embodiments and variations that may be utilized without departing from the spirit and scope of the invention to maintain the advantages of the present invention over existing home lifts and stair climbers.

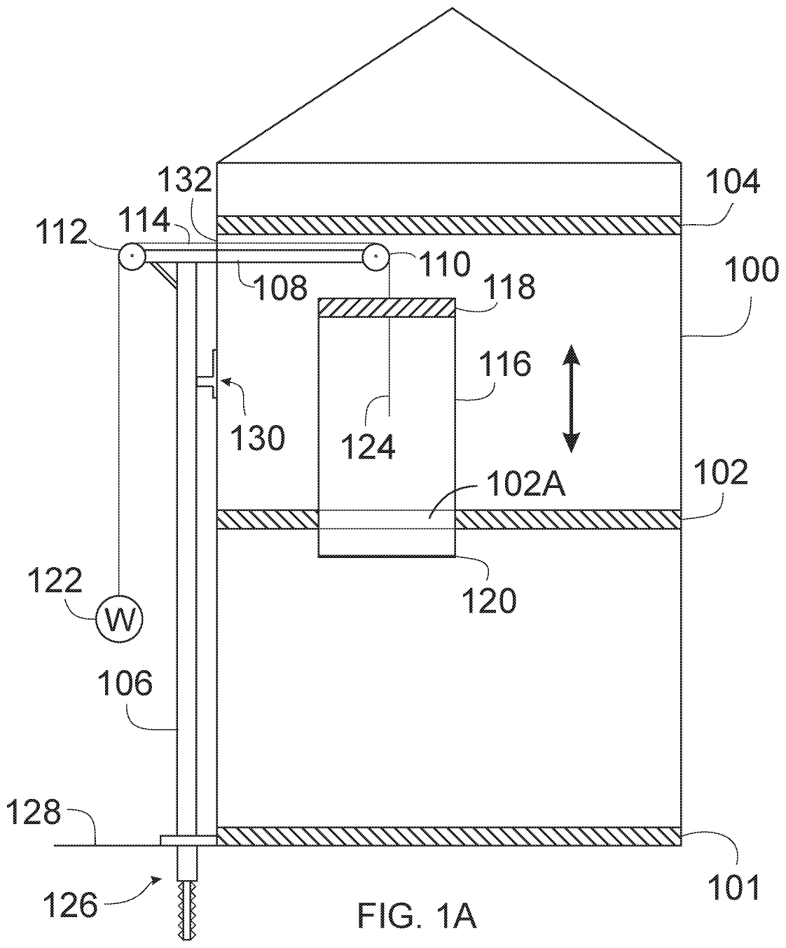

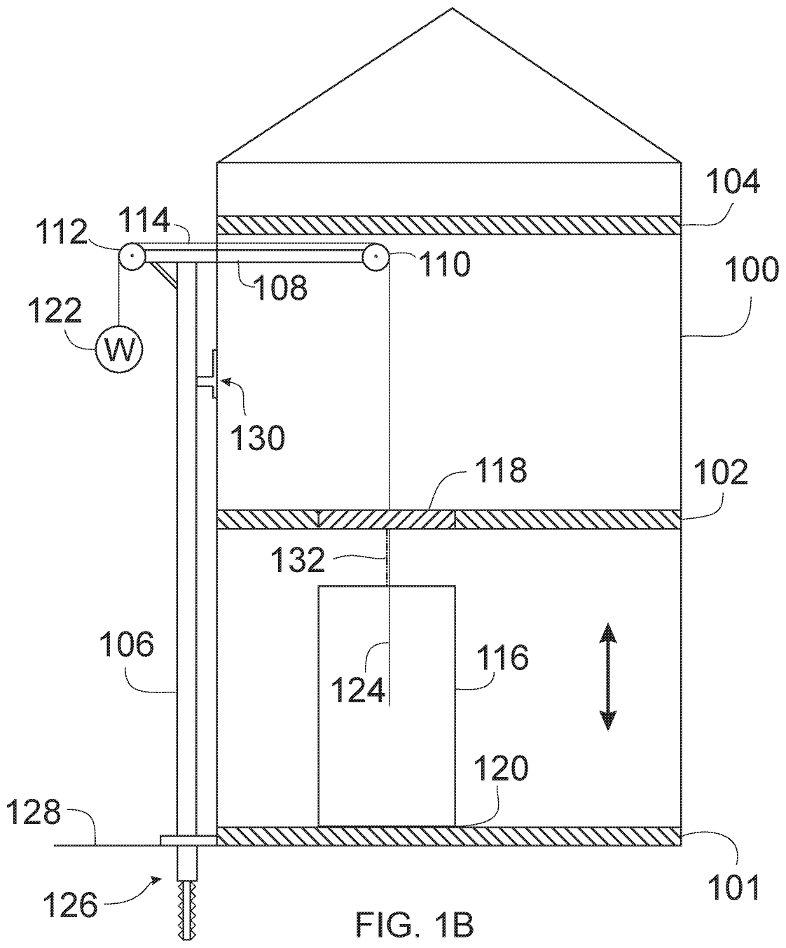

Referring now to FIGS. 1A-B, the components of the low-cost lift installed in a house 100 will be described below. The house as illustrated is a two story house having a first floor 101, a second floor 102, and a ceiling 104. It should be understood, that the present invention is not limited to two floors homes. In one embodiment, the lift comprises a support post 106 and horizontal support 108, wherein the horizontal support includes a distal and proximal end. The support post is configured to be installed adjacent to an outside wall of the home, wherein the horizontal support is configured to enter the inside of the home. In one embodiment, the horizontal support is configured to pass through a window 132 of the home. It should also be noted that this is just one embodiment, and the structural support for the lift may be located inside the house, as will be discussed below. The critical aspect of the invention, regardless of the support structure is that the lift is balanced and enabled to be operated with minimal force without the use of electric motors.

In one embodiment, the distal end is configured to hold a first at least one pulley 110 and the proximal end is configured to hold a second at least one pulley 112. The first and second at least one pulley configured to receive at least one rope 114. A carriage 116 is situated and attached to an end of the at least one rope and a counterweight 122 is positioned at the other end of the at least one rope. The center of gravity of the carriage and counterweight should be positioned directly in line with the first and second pulleys. In some embodiments, the at least one rope is two ropes, including a main cable and a safety rope. This will be discussed in further detail below.

In one embodiment, the carriage is configured to transport a single passenger. In one embodiment, the carriage is a cage with a gate. In alternative embodiments, the carriage includes doors configured to open and close to allow access to for the passenger. Preferably, the carriage is sized and shaped to enable a passenger to enter with a mobility vehicle, such as a wheelchair, or the passenger can enter the carriage on foot. In one embodiment, inside the carriage a seat (not shown) may be provided enabling the passenger to sit if desired during travel. In one embodiment, the carriage includes a handgrip (not shown) configured to support a standing passenger as well known in the art. The carriage includes floor/ceiling portion 118 connected by chain 132, wherein the floor/ceiling portion is configured to replace opening 102A on second floor 102 when the carriage is below second floor height. Preferably, the carriage is approximately 7 feet in height, wherein the height is based on the standard 8 feet height between the floor and the ceiling. For higher ceilings this may be adjusted. Alternatively, the length of chain 132 may be adjusted to account for vaulted ceilings. The slack of the chain enables carriage to be positioned on the first floor, defined as bottom portion 120 of the carriage aligned with first floor 101. The floor/ceiling portion 118 rests on the top portion of the carriage when the carriage is above the second floor, such as illustrated in FIG. 1A.

In one embodiment, the counter weight is equal to the weight of the carriage plus the passenger including any mobility devices, herein “the load.” The balanced nature of the present invention in relation to the weight distribution between the counter weight and the load enables ease of operation without the use of motorized assistance. It should be understood, that the counter weight is variable and can be adjusted to accommodate changes in operational loads.

In one embodiment, an additional rope 124 is positioned inside the carriage, wherein the additional rope is used to facilitate the movement of the lift during use. In some embodiments, additional rope may include two additional ropes, a first additional rope to direct the carriage upwards and a second additional rope to direct the carriage downwards, wherein the first additional rope is attached to the counterweight and the second additional rope is attached to a fixed location, such as the tower. For instance, during use, the passenger may enter the carriage and apply force to the first additional rope intended to direct the carriage upwards. Due to the almost frictionless nature of the relationship between the counter weight and the load, the force needed to move and stop the carriage is minimal. Various safety features may be provided to assist the carriage from stopping or to prevent the carriage from traveling too fast. In one embodiment, a brake is provided to slow or stop the carriage. In another embodiment, springs may be provided to absorb and prevent harsh impact forces when the carriage makes a stop at a respective floor. In another embodiment, an additional rope adjacent to the carriage attached to the ceiling, tower, or other fixed location may be used to leverage the carriage to move in either an upwards or downward direction, as there is little force required to move the carriage due to the equal weight balance of the load and counterweight, effectively eliminating the effect of gravity.

In one embodiment, the carriage is locked in place when the passenger or load is not is not in the carriage. This prevents the carriage from traveling upward when the weight balance is not provided. In some embodiments, the gate operation is in conjunction with the lock, such that when the passenger exits the carriage the gate opens and locks the carriage in place. The gate may only close when the passenger enters the carriage and closes the gate from the inside. Further, one or more cleats may be provided, enabling the passenger to tie down the carriage as a safety precaution. Yet further, a brake system may be engaged on the at least one rope preventing the carriage from moving.

In one embodiment, the at least one rope is at least two ropes, including a main rope and a backup rope in case the main cable or its connections fail. Each cable of the at least two cables are configured for support the weight of the load and counterweight. It is critical that each cable alone is capable of supporting the weight of the load and counterweight alone, such that if one cable fails the other cable can handle the load. In one embodiment, main robe is a steel rope and the backup rope is a Kevlar rope.

In one embodiment, the first and second at least one pulley 110 and 112 may include two grooves to accept the main and backup ropes. In some embodiments, a safety brake system may be provided and configured to reduce the size of the grooves and compress the ropes in an emergency. It is essential that there is protection in case of a rope or connection failure. Thus, a safety or backup rope must be provided. In some embodiments, an overspeed device is provided to catch a falling load.

Various support features can help support and stabilize support post, including underground supports 126 below the ground level 128 as well as wall supports 130. Any support techniques and method known in the art may be used.

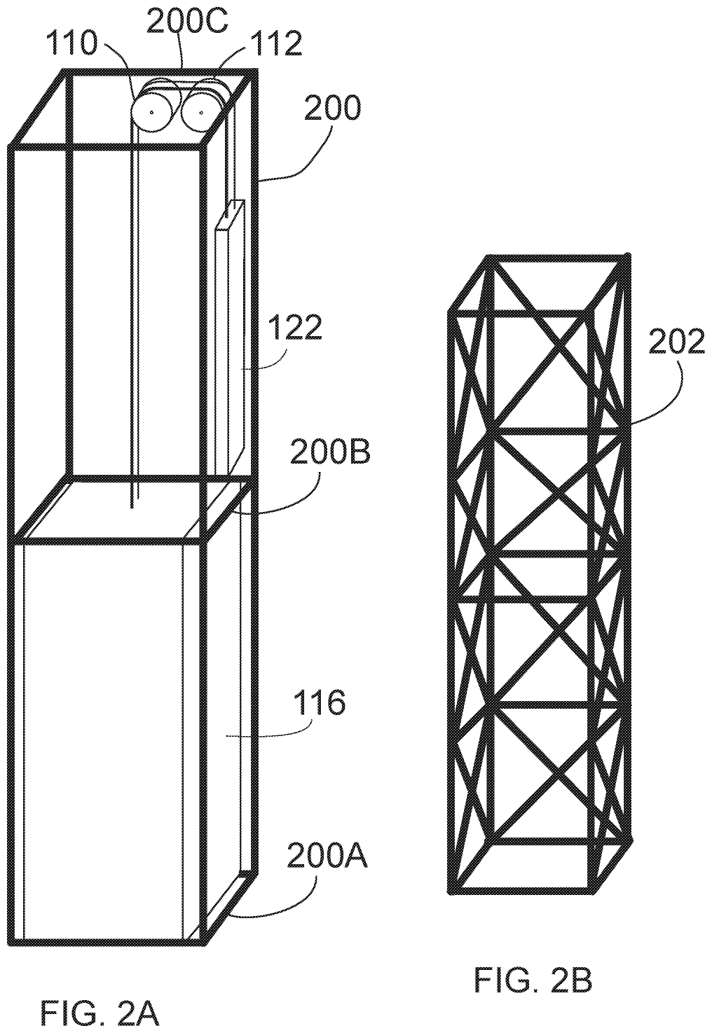

Referring now to FIGS. 2A-B, preferred support structures are provided. In one embodiment, a temporary tower 200 may be used to support the present invention. The tower can be installed inside the home or outside the home. In some embodiments, the tower frame 200 may be used to support existing floor/ceiling joists and the components of the present invention. This will be described in further detail below.

Preferably, the tower is a temporary scaffold tower assembled with toggle pins. The frame includes a floor support section 200A, a mid-support section 200B, and a top support section 200C. In this embodiment, the top support section is configured to support the first and second at least one pulleys 110 and 112. The floor support section is at or below the first floor of the home, the mid-support section is at or below the second floor of the home, such as in the first floor ceiling and the top support is above the ceiling of the second floor such that some components may he hidden from view, such as the pulleys 110 and 112. In some embodiments, for added support the frame includes cross braces 202. In alternative embodiments, the tower frame may be omitted if the roof beams or a support wall are strong enough to support the components of the present invention. The tower frame should have no loose parts.

Regarding installation, one method for installing the home lift is to select a second floor location and to cut an opening in the floor, wherein the opening corresponds to a safe landing area on the first floor below. It should be understood, that although the second and first floors have been used as an example, it may be any floor in ascending or descending order as previously discussed. For instance, the third and second floors. Further, although the disclosure describes a two floor lift, there is no limit to the number of floors the present invention may travel.

In one embodiment, prior to making the cut in the selected location, a 3D imaging device may be used to determine if the location is suitable. The 3D imaging device allows a user to see if there are any pipes, electrical consideration, etc. that would require a different location to be selected. In one embodiment, supports may be installed if any floor/ceiling joists are needed to be removed for installation. Then the lift is installed with the support structure and component previously discussed. Further installation details and supporting techniques are disclosed in Applicant's application by reference Ser. No. 16/015,186. In some embodiments, the components of the improved home lift may be supported via an existing support wall, roof beams, vertical beam, or a combination thereof. If the existing support members (roof beam, support wall, etc.) are not strong enough or are not in the best location for the improved home lift then the tower frame may be used.

In one embodiment, only one or two floor joists need to be cut to allow for the tower to be installed. Advantageously, these floor joists may be used for braces for the tower, and the tower may support the cut ends of the floor joists. After the need for the present invention, the floor joists that were cut are simply replaced and remounted, and the floor is refinished.

In most installations, the improved home lift will only be used twice a day, to leave and reach the upper bedroom and shower. Advantageously, because of the many optional location choices, the lift can be installed in a hidden or unobtrusive location.

Third, as previously discussed, if a tower frame is provided, the frame is supported at multiple points. Vertical sections of the tower are capable of being supported by a support wall or a vertical beam. Likewise, the floor support section 200A, mid-support section 200B, and top support section 200C may be supported by floor/ceiling beams, as the total weight would be less than 1,000 pounds. If the lower floor support is not certain, a steel post shore could be added to support it. Further, the tower frame itself, especially when cross braces are provided, is self-supporting.

Due to the simplistic design and components used, the home lift will cost less than any existing home lift of the prior art and most stair climbers but with many advantages.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, itis to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, in an alternative embodiment, a winch, such as a single or double drum hoist winch may be mounted above the carriage to facilitate automatic operation without the need for manual power. In some embodiments, a hand drill may be used to wind one or more ropes to move the carriage in an upwards or downwards direction providing a battery powered solution if necessary for operation. Also, in other embodiments, additional pulleys may be utilized to create a mechanical advantage, lowering the required weight of the counterweight.

What is claimed is:

1. A home lift comprising:
a carriage sized and shaped to carry a passenger with an optional mobility vehicle, the carriage, the passenger, and the optional mobility vehicle defined as a load having a first weight;
a counterweight having a second weight, wherein the first weight is equal to the second weight;
a set of pulleys configured to guide two ropes, wherein the two ropes are attached to the carriage and the counterweight; and,
wherein the passenger using a manual force may move the carriage between at least two adjacent floors in the home.

2. The home lift of claim 1, further comprising a self-supporting temporary tower frame configured to support the home lift.

3. The home lift of claim 2, wherein the set of pulleys is attached to the tower frame.

4. The home lift of claim 2, wherein the tower frame includes cross braces.

5. The home lift of claim 1, wherein the home lift is supported by an existing support wall or roof beam.

6. The home lift of claim 1, further comprising a support post and a horizontal beam configured to support the home lift, wherein the horizontal beam is configured to support the set of pulleys and the support post is situation outside the home.

7. The home lift of claim 1, wherein the horizontal beam is configured to enter a window of the home.

8. The home lift of claim 1, further comprising a third rope attached to the counterweight, wherein the passenger using the third rope is enabled to raise the carriage.

9. The home lift of claim 8, wherein a battery operated winch or hand drill connected to the third and/or fourth rope is operable to move the carriage between the at least two adjacent floors in the home such that the manual force is not required.

10. The home lift of claim 1, further comprising an additional rope attached to a fixed location, wherein the additional rope enabled the passenger the required leverage force to move the carriage between the at least two adjacent floors in the home.

11. The home lift of claim 1, wherein the at least two ropes include a main rope and a backup rope, wherein the main rope is a steel rope and the backup rope is a Kevlar rope.

12. The home lift of claim 11, wherein the set of pulleys includes two grooves for the main rope and the backup rope.

13. The home lift of claim 1, wherein the carriage includes a locking mechanism configured to lock the carriage in place when the load is not in the carriage preventing the carriage from traveling.

14. The home lift of claim 13, wherein the carriage includes a gate and the gate operation is in conjunction with the locking mechanism, such that when the passenger exits the carriage the gate opens and locks the carriage in place.

15. The home lift of claim 1, further comprising one or more cleats enabling the passenger or an aide to tie down the carriage via a rope to prevent unwanted movement.

16. The home lift of claim 1, further comprising a brake system configured to engage the at least two ropes preventing e carriage from moving when the brake system is engaged.

17. The home lift of claim 1, wherein the carriage is stationary until a small force is applied to raise or lower the carriage.

18. The home lift of claim 1, further comprising an additional stationary rope fastened to a fixed location, wherein the additional stationary rope is within reach of the passenger inside the carriage such that the manual force may be applied to raise, lower, or stop the carriage.

19. The home lift of claim 1, further comprising an additional movable rope configured to travel with the counterweight and the load, the additional movable rope enabling a user outside the card age to raise, lower, or stop the carriage.

20. The home lift of claim 11, further comprising an auxiliary overspeed with a safety rope in case of a rope failure.
